(19) United States
(12) Patent Application Publication
(10) Pub. No.: US 2015/0151853 A1
(43) Pub. Date: Jun. 4, 2015

(54) METHOD FOR IMPROVING OVERALL AIRPORT AIR QUALITY DURING AIRCRAFT GROUND OPERATIONS

(71) Applicant: Borealis Technical Limited, North Plains, OR (US)

(72) Inventors: Rodney T. Cox, North Plains, OR (US); Isaiah W. Cox, Baltimore, MD (US); Aaron Bianco, University City, MO (US)

(21) Appl. No.: 14/401,843

(22) PCT Filed: May 18, 2013
(86) PCT No.: PCT/US2013/041735

§ 371 Date: Nov. 18, 2014

Related U.S. Application Data
(60) Provisional application No. 61/648,603, filed on May 18, 2012.

(51) Int. Cl. B64F 1/26; B64C 25/40; G05D 1/02; G05D 1/00

(52) U.S. Cl. CPC B64F 1/26; G05D 1/0088; B64C 25/405; G05D 1/0202

(57) ABSTRACT

A method is provided for improving overall air quality at airports during ground operations that includes providing a plurality of aircraft landing and taking off from an airport with onboard drive means controllable to move the aircraft on the ground without reliance on aircraft main engines or external tow vehicles while significantly minimizing operating time of aircraft engines after landing and/or prior to takeoff. As the number of aircraft equipped with onboard drive means for ground movement increases, levels of undesirable engine exhaust components in airport exterior ambient air, in airport ground facilities interior air, and in geographical areas surrounding the airport decrease as a result of the replacement of both the aircraft engines and the operation of external tow vehicles by the onboard drive means. Aircraft engines are not started until the aircraft reaches a takeoff runway where engine exhaust emissions are more readily dissipated by the taxiing aircraft.

### PRIORITY CLAIM

This application claims priority from U.S. Provisional Application No. 61/648,603, filed May 18, 2012, the disclosure of which is fully incorporated herein.

### TECHNICAL FIELD

The present invention relates generally to air quality at airports, airfields, aerodromes, and the like, as well as in airport terminals and auxiliary buildings, and specifically to a method for improving the quality of air at all such facilities during aircraft ground operations.

### BACKGROUND OF THE INVENTION

Aircraft landing, taxiing, and taking off at airports contribute significantly to both noise and air pollution not only at airports, but also in airport terminal buildings and in other auxiliary buildings commonly found at an airport facility, and in the geographic areas surrounding airports. Parking garages, hangars, Federal Aviation Administration (FAA), and other facilities located within or near an airport may additionally be subject to noise and air pollution produced by aircraft. One study indicated that Los Angeles International Airport is the largest source of carbon monoxide (CO) in the state of California. Both the number of aircraft using airports and aircraft taxi time have increased substantially during the last 20 years. One estimate suggested that this increase has amounted to over one million aircraft hours when aircraft engines are idling on runways. Not surprisingly, local ambient air pollution levels at and around airports, including those within the airport buildings and facilities described above have increased significantly. Growth in air traffic and the expansion of airport runways and physical facilities to meet demands for air travel are expected to exacerbate this situation.

Studies in both Europe and the United States have demonstrated that airport air pollution has adverse health impacts, particularly in areas adjacent to airports, airfields, and aerodromes and potentially within airport terminals and auxiliary buildings as well. One study noted that carbon monoxide (CO) may have a greater effect on human health than ozone or nitrogen oxides and that even relatively small amounts of CO can affect the incidence of respiratory illness and increase hospitalization costs for such illness. Another study indicated that air traffic-related nitrogen oxides, especially NO₂, and particulate matter (PM)can adversely affect not only people living close to airports, but also those living at some distance, as aircraft emissions may be transported over long distances and transformed into secondary pollutants in the atmosphere. When these pollutants are able to enter airport terminals and/or airport auxiliary buildings, the associated health risks can also expand to these spaces.

While improvements in the quality of fuel burned by aircraft and careful attention to an aircraft engine's specific emission index can help reduce NO₂ emissions, aircraft emissions of CO and other hydrocarbons are not significantly affected. These emissions (CO and other hydrocarbons) tend to be particularly high during aircraft taxi, when aircraft engines are operating at less than optimal efficiency. Reducing aircraft idling and taxi time, especially longer taxi-out times, to achieve reductions in undesirable aircraft engine emissions has been proposed. For example, the use of high speed tugs to tow aircraft so engines do not have to be used, parking aircraft closer to runways, and congestion reduction measures, including holding aircraft at a gate until a runway is ready for the aircraft to take off, have all been suggested. U.S. Patent Application Publication No. US2011/0060485 to Chaptal et al discloses a method and device for optimizing a takeoff procedure of an aircraft designed to minimize noise and reduce the environmental impact of aircraft CO₂ and NO₂ emissions at an airport and the geographic area surrounding the airport. This aircraft traffic management approach, if followed carefully, may mitigate emissions to some extent prior to takeoff. However, it may not be universally applicable to aircraft at all airports to significantly reduce undesirable emissions generated during aircraft taxi.

Other approaches for reducing aircraft emissions have also been suggested, such as the use of aircraft engine exhaust gas purifying devices to reduce aircraft emissions described in U.S. Patent Application Publication No. US2003/0010865 by Maehara. Although helpful, this system requires operation of an aircraft's engines during taxi. Moving an aircraft on the ground during taxi by means other than the aircraft's main engines or turbines or external tow vehicles has been described in the art. U.S. Pat. Nos. 7,975,960 and 8,220,740 to Cox et al, owned in common with the present application, describe a nose wheel control apparatus capable of driving a taxiing aircraft without the use of the aircraft main engines or tow vehicles. In U.S. Pat. No. 7,445,178, McCoskey et al describe a powered nose aircraft wheel system useful in a method of taxiing an aircraft that can minimize the assistance needed from tugs and the aircraft engines. U.S. Pat. No. 7,226,018 to Sullivan also describes a wheel motor useful in an aircraft landing gear wheel designed to provide motive force to an aircraft wheel when electric power is applied. U.S. Patent Publication No. US2009/0294577 to Rogues et al describes a device that enables an aircraft to move autonomously on the ground that employs a very specifically defined spiral drive gear to turn an aircraft wheel. Although Rogues et al acknowledges contributions aircraft engines can make to noise and atmospheric pollution, neither Rogues et al nor any of the other patents or published patent applications are specifically directed to a method for improving air quality at airports or in airport terminals or auxiliary buildings and spaces and/or in the geographic areas surrounding airports during ground operations.

A need exists for a method specifically directed to improving air quality inside and outside airports and in the surrounding geographic areas during airport ground operations.

### SUMMARY OF THE INVENTION

It is a primary object of the present invention, therefore, to provide a method for improving air quality at airports, in airport terminals and auxiliary buildings and spaces, as well as in the geographic areas surrounding airports during airport ground operations.

It is another object of the present invention to provide a method for substantially eliminating undesirable aircraft emissions during aircraft taxi.

It is an additional object of the present invention to provide a method for minimizing air pollution from non-aircraft ground vehicles at an airport during ground operations.

It is a further object of the present invention to provide a method for substantially reducing health risks resulting from aircraft emissions during airport ground operations.

It is yet a further object of the present invention to provide a method for efficiently moving aircraft during taxi that substantially reduces or eliminates a range of aircraft emissions products identified with undesirable air quality.

It is yet an additional object of the present invention to provide a method for improving air quality at an airport, in airport terminals and auxiliary buildings, and in the surrounding geographical area that enables a large number of aircraft to maneuver during ground operations while minimizing the time aircraft engines are operating.

It is a still further object of the present invention to provide a method for improving overall air quality, including the quality of external ambient air in and around an airport and the quality of interior air within airport buildings and other enclosed structures in and around an airport.

The foregoing objects are achieved by providing a method for improving overall air quality at airports during ground operations that includes providing a plurality of aircraft landing and taking off from an airport with onboard non-engine drive means controllable to move the aircraft on the ground without reliance on aircraft main engines or external tow vehicles while significantly minimizing operating time of aircraft engines after landing and/or prior to takeoff. As the number of aircraft equipped with onboard drive means for ground movement increases, levels of undesirable engine exhaust components in ground level airport ambient air decrease as a result of the replacement of both the aircraft engines and the operation of external tow vehicles by the aircraft onboard non-engine drive means. Aircraft engines are not started until the aircraft reaches a takeoff runway where engine exhaust emissions are more readily dissipated by the taxiing aircraft. The increased quality of ground level ambient air during airport ground operations concomitantly increases air quality in all airport facilities as well as in the geographic area surrounding the airport.

Other objects and advantages will be apparent from the following description, drawings, and claims.

### BRIEF DESCRIPTION OF THE DRAWING

FIG. 1 illustrates an airport ramp and taxiway where a plurality of the aircraft shown are equipped with onboard non-engine drive means controllable to move the aircraft on the ground during taxi and pushback without reliance on the aircraft main engines or external tow vehicles, improving airport air quality in accordance with the present invention.

### DESCRIPTION OF THE INVENTION

Airport air quality is affected by emissions from sources other than aircraft; however, aircraft account for the substantial majority of the emissions that can adversely affect airport air quality. Ground support vehicles and equipment powered by fossil fuels can also negatively affect airport air quality during ground operations. The air quality in and around airports is negatively impacted by air polluted by emission from aircraft and ground vehicles. This polluted air is available to be drawn into airport terminal buildings, as well as into a range of airport auxiliary buildings and other facilities, such as, but not limited to, hangars, repair facilities, FAA facilities, parking garages, and control towers. The air quality of other buildings that may be located adjacent to or very near airports, for example hotels and office buildings, can be negatively affected when the air drawn into a building's air circulation has undesirable levels of airport emissions. While air drawn into buildings and other facilities within or near an airport can be filtered, some of the most noxious components of aircraft jet engine emissions, particularly incompletely combusted hydrocarbons, are not easily removed and can be present at undesirable levels, even in the interior air of the aforementioned facilities. The negative effects on air quality are not limited to within or adjacent to airport boundaries, but can extend a substantial distance beyond the confines of the airport. As noted above, approaches to reducing undesirable aircraft emissions and improving airport air quality have included improving aircraft fuel blends and engine fuel combustion, aircraft aerodynamic structure, and airline operational efficiency. Most of the measures proposed will take time to institute, however, and improvements in airport air quality during ground operations are not likely to be achieved quickly with them. With the method of the present invention, it is possible to produce a significant improvement in overall airport air quality during ground operations relatively quickly. When the present method for moving aircraft at an airport during taxi is combined with systems proposed to manage and optimize airport aircraft and other ground traffic, even greater improvements in both total airport air quality and ground operations efficiency can be realized.

The method of the present invention includes equipping a significant number of aircraft landing, taxiing, and taking off at an airport with onboard non-engine drive means controllable to move the aircraft autonomously on the ground without reliance on operation of the aircraft main engines or external tow vehicles. Equipping even one aircraft with such a drive means will have a positive effect on airport air quality. Each additional aircraft equipped with onboard non-engine drive means that move aircraft during taxi without the operation of an aircraft's main engines further enhances this positive effect. Not only is airport air quality improved, but noise pollution can also be substantially eliminated. The improvements in ground level air quality possible when aircraft engines are not used for taxi and when tugs or external tow vehicles are not used for pushback affect everyone present on the ground, particularly in ramp areas, but anywhere ground personnel work near aircraft. The substantial reduction in noise made possible by the present method additionally provides a cleaner, quieter ramp environment and enables ground personnel to work more efficiently during aircraft turnaround.

Eliminating the operation of an aircraft's main engines to move the aircraft on the ground between takeoff and landing, moreover, can significantly reduce undesirable ground level exhaust gases. An operating aircraft engine burns fuel at about 25-29 pounds per minute (lb/min). Studies have shown that aircraft engines operating at low engine loads, such as, for example, at the 4% load typical of ground idle, do not operate efficiently and produce emissions with more undesirable components than aircraft engines operating at higher loads, including those associated with climb out (85% of maximum thrust) and approach (30% of maximum thrust). These undesirable emissions components have a substantial impact on the quality of ground level air where aircraft engines are operating at the low thrust levels typically used during ground operations. Additionally, the exhaust emissions produced by starting an aircraft engine during slow pushback or while stopped, which is current practice, are particularly noxious and undesirable, since they contain the incomplete combustion products of an inefficiently operating engine. These incomplete combustion products become part of an airport's ambient environment, as well as part of the environment surrounding the airport.

Reduction in levels of undesirable ground level aircraft engine emissions, including, for example, without limitation, carbon monoxide, carbon dioxide, nitrogen oxides, sulfur oxides, volatile organic compounds (VOCs), semi-volatile organic compounds (SVOCs), particulate matter, and the like, at an airport is achieved in accordance with the present method by eliminating the use of an aircraft's main engines to move the aircraft on the ground. Aircraft engine starts can be delayed until the aircraft has completely left the ramp area and is taxiing on a takeoff runway, which is usually a considerable distance from the ramp area. In addition, external tow vehicles or tugs, which are typically powered by fossil fuel-burning internal combustion engines, are not required to move aircraft on the ground when the aircraft engines are not operating, which eliminates another source of ground level exhaust gases. As described below, the aircraft's auxiliary power unit (APU) provides the power for an onboard non-engine drive means to move the aircraft autonomously during ground operations. The APU, which burns about 4 pounds of fuel per minute (lb/min) compared to the 25-29 lb/min burned by an aircraft engine, represents a significant reduction in fuel burn and a correspondingly significant reduction in undesirable fuel combustion products in the air around an aircraft with an operating APU. Consequently, an aircraft jet engine operating inefficiently at idle could have a greater adverse effect on ground air quality than an APU at operating efficiently at a normal operating speed.

One or more drive means may be drivingly associated with one or more of the aircraft's landing gear wheels to produce one or more drive wheels. Either and/or both of the nose landing gear wheels or the main landing gear wheels can be equipped with onboard non-engine drive means capable of powering one or more aircraft wheels to move the aircraft autonomously during airport ground operations. The onboard non-engine drive means can be controlled to power the one or more wheels with which the drive means is drivingly associated and drive these wheels to move the aircraft autonomously and independently during taxi and other ground travel without reliance on the aircraft's engines. This substantially eliminates all of the challenges associated with requiring engines designed to move an aircraft during flight to, instead, move the aircraft on the ground. Consequently, jet blast, engine ingestion, noise, and other adverse effects of engine operation to move an aircraft during ground maneuvers no longer contribute to airport ground operations safety issues. Additionally, as noted above, exhaust gases containing undesirable products of combustion produced by aircraft engine operation are not discharged into the ground level ambient air and, therefore, are not available to negatively affect the air quality of the exterior or interior of the airport facilities described above.

In a preferred arrangement, each of a pair of aircraft nose or main landing gear wheels may have a drive means drivingly associated with a wheel to provide the power required to drive a commercial sized aircraft on the ground, although a single drive means powering a single wheel may be suitable in some situations. All possible numbers and locations of the wheel or wheels driven by a drive means are contemplated to be within the scope of the present invention. Suitable control means are preferably provided to allow the automatic or manual control of the drive means to drive the aircraft autonomously during taxi and other ground movement.

A non-engine drive means suitable for use with the method of the present invention can be any of a number of possible drive means suitable for powering an aircraft wheel and driving an aircraft autonomously during ground travel without reliance on the aircraft's main engines. Drive means useful for this purpose may be selected from those known in the art. One preferred drive means is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Any form of electric motor capable of driving an aircraft on the ground during ground travel, including but not limited to electric induction motors, permanent magnet brushless DC motors, and switched reluctance motors, as well as other drive means, including, but not limited to, hydraulic pump/motor assemblies and pneumatic motors, may also be used to power drive wheels in an aircraft ground travel system designed to move an aircraft autonomously on the ground.

A particularly preferred drive means, suitable for use in, for example, the Boeing 737 family of aircraft and the Airbus A320 family of aircraft, is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel in a particular runway environment could be achieved and maintained. Other motor designs capable of high torque operation across a desired speed range that can be integrated into or otherwise drivingly associated with an aircraft nose or main gear drive wheel to function as described herein may also be suitable for use in the method of the present invention.

The aircraft's auxiliary power unit (APU) is, as indicated above, the preferred source of electric power for powering drive means that require electric power. Other power sources may also be used to supplement or replace the APU as a source of power. These power source can include, for example without limitation, batteries, fuel cells, any kind of solar power, POWER CHIPS™, and burn boxes, as well as any other suitable power source for this purpose. Control of the flow of current to the drive means, as well as control of the voltage and frequency of the current, allows torque generated by the drive means to be controlled and, therefore, provides control of the speed of the wheel powered by the drive means and the ground travel speed of the aircraft. In the event the APU or one of the aforementioned power sources is not available, as noted above, electric power may be generated by one or more of the aircraft's engines' auxiliary power units to power the aircraft wheel drive means and keep the aircraft moving on the ground, although this is not preferred and would be employed only in an emergency situation.

In a busy ramp area, such as, for example, at London's Heathrow Airport, where large numbers of departing aircraft must be pushed back prior to takeoff as quickly as possible while equally large numbers of aircraft are arriving, engine starts by aircraft in the ramp area during or after pushback currently produce noxious engine exhaust gas emissions. When aircraft are equipped with onboard non-engine drive means according to the present method, the aircraft moves autonomously without engine operation to a takeoff runway, and engine starts are delayed until an appropriate time before the aircraft takes off. When an aircraft equipped with onboard non-engine drive means starts its engines, the aircraft should be taxiing on a takeoff runway, usually distant from an airport terminal, and the movement of the aircraft will help to dissipate engine exhaust emissions. Wind currents, which are usually notably lacking in the ramp area, can also help to dissipate emissions produced by engine starts just prior to takeoff so that overall airport ground level air quality may be adversely affected for only a very short time. The level of aircraft emissions may be significantly reduced compared to the emissions levels produced when aircraft engines and/or tugs are required for pushback and taxi.

If all of the aircraft at an airport are equipped with onboard non-engine drive means according to the present invention, the aircraft engines are not operating, and exhaust gases are not produced. The airport environment, particularly in the ramp and close to the airport terminal, therefore, does not contain the undesirable components of engine exhaust gases that compromise and lower air quality. Consequently, other airport exterior and interior facilities, such as, for example, hangars, maintenance areas, FAA facilities, and parking garages, will also not be subjected to these undesirable exhaust components. The more aircraft at an airport that are equipped with onboard drive means for ground movement and do not require operation of aircraft engines for taxi or tugs for pushback or movement between landing and takeoff, the lower the levels of undesirable emissions will be in the total airport environment and in surrounding geographical areas, and the cleaner the ambient air drawn into aircraft interiors will be.

If the aircraft APU is used as the source of electric power to power onboard non-engine drive means to move the aircraft during taxi, the APU currently requires aircraft fuel to operate. The level of emissions produced by an APU compared to those produced by an aircraft's main engines, however, is significantly and substantially lower and should not adversely affect air quality if the APU is operating properly. It is expected that a reduction in pollutants produced by operation of the APU compared to operation of aircraft engines of about 90 to 95% can be achieved with the present method. Moreover, a 100% reduction in ground air pollutants produced by tow vehicles is possible with the present method since these vehicles will no longer be required.

All likelihood of the production of undesirable emissions and products of combustion that could adversely affect overall air quality of all airport facilities during aircraft ground travel or operations, particularly in ramp and taxi areas, could be substantially eliminated by equipping all aircraft landing and taking off at an airport with onboard non-engine drive means as described above.

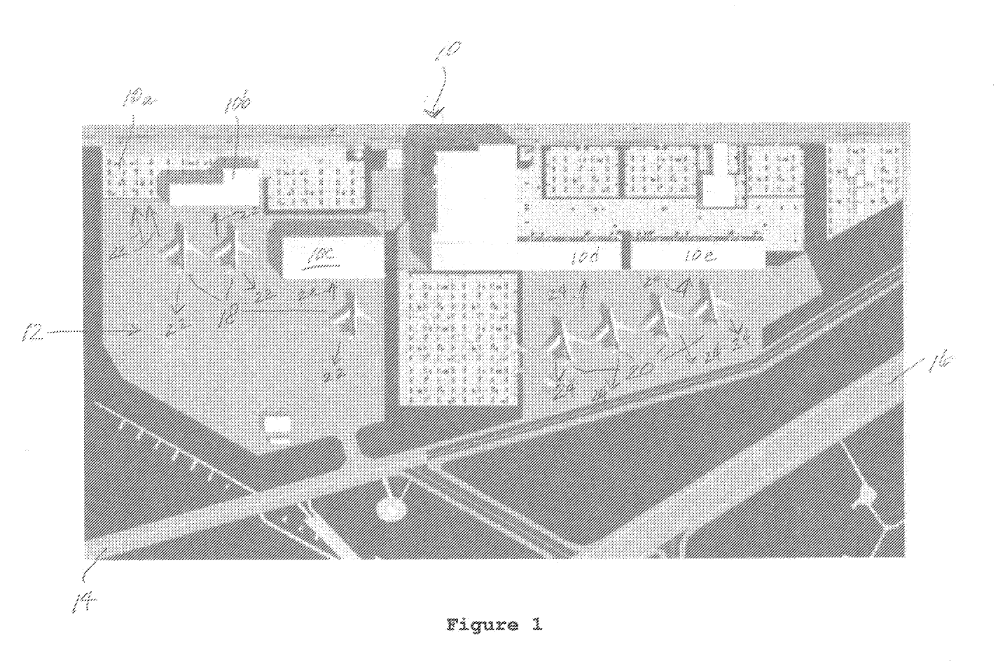

Referring to the sole drawing, FIG. 1 illustrates a portion of an airport, including a terminal building 10, a ramp area 12, a taxiway 14, and a runway 16. Aircraft 18 are shown in the process of arriving, and aircraft 20 are shown at parking locations ready for pushback. Currently, arriving aircraft 18 taxi to their respective parking locations near terminal 10 using the power provided by the aircraft engines. Even operating at low or idle thrust, emissions from the aircraft engines are discharged into the ramp area surrounding the terminal 10 and are also available to be drawn into the interior air circulation of terminal sections 10a, 10b, and 10c, such as along the paths represented by the arrows 22. Departing aircraft 20 are currently pushed back by tugs (not shown), which also produce engine emissions, to a location, generally to a location near the airport terminal 10, where aircraft engines will be started. Engine emissions, represented by arrows 24, are produced by these engine starts and are available to be drawn into terminal sections 10d and 10e. Some of these engine emissions will also remain in the ramp 12 or gate area.

In today's congested airport ramp and gate areas, arriving aircraft 18 are not usually likely to be separated from departing aircraft 20, as shown in FIG. 1. Rather, an arriving aircraft may have to wait, with engines running, while a departing aircraft is pushed back by a tug powered by an internal combustion engine so that the departing aircraft can then start its engines and leave the ramp area 12. The engine emissions generated by these maneuvers are both present in the ambient ground level air and available to be drawn into the air circulating within the terminal 10, as well as into the interior air of any nearby airport building or facility, as well as into adjacent and nearby aircraft. The intake air of any of the airport buildings, facilities, or enclosed spaces described above could include undesirable aircraft engine emissions components discharged virtually anywhere at an airport where these components can find their way into air handling or conditioning equipment.

When a plurality, preferably all, of the aircraft 18 and 20 and the other aircraft using an airport are equipped with onboard non-engine drive means controllable to move the aircraft during ground maneuvers between landing and takeoff as described herein, operation of the main aircraft engines is substantially, if not completely, eliminated when the aircraft are taxiing between a landing runway and an arrival or parking destination near the terminal 10. The use of a tug or tow vehicle is not required to push aircraft back, eliminating this source of airport ground emissions. Operation of the aircraft's engines is additionally not required following pushback and during ground travel until the aircraft arrives at a specified point on a takeoff runway where engines must be started to accomplish takeoff. As a result, not only is exterior air quality at an airport significantly improved, but the air quality within buildings and enclosed spaces at or near and airport and air quality within aircraft is also significantly improved.

While the present invention has been described with respect to preferred embodiments, this is not intended to be limiting, and other arrangements and structures that perform the required functions are contemplated to be within the scope of the present invention.

### INDUSTRIAL APPLICABILITY

The present invention will find its primary applicability where it is desired to achieve significant improvements in the overall quality of exterior and interior air at airports, within airport buildings and other facilities, and in the geographical areas surrounding airports.

1. A method comprising improving overall air quality at an airport wherein one or more aircraft landing and taking off at an airport are equipped with one or more onboard non-engine drive means controllable to move the aircraft autonomously on the ground during ground operations without reliance on aircraft engines or external tow vehicles and said drive means are controlled to move aircraft on the ground to effectively substantially eliminate and prevent the addition of undesirable gases and particulate components generated by aircraft engine operation to airport ambient air and to ambient air drawn into airport enclosed spaces.

2. The method of claim 1, wherein the overall air quality at an airport is improved by equipping a plurality of aircraft using an airport with one or more of said non-engine drive means.

3. The method of claim 1, wherein said undesirable gases comprise carbon monoxide, carbon dioxide, nitrogen oxides, sulfur oxides, volatile organic compounds, and semi-volatile organic compounds.

4. The method of claim 1, wherein the airport enclosed spaces comprise terminal buildings, hangars, parking facilities, maintenance facilities, FAA facilities, control towers, office buildings, and hotels within and near the airport.

5. The method of claim 1, wherein one or more nose wheels or main wheels of said aircraft are equipped with one or more of said drive means.

6. The method of claim 1, wherein noise pollution from operation of said aircraft engines is substantially eliminated.

7. The method of claim 1, wherein all aircraft landing and taking off at an airport are equipped with one or more of said drive means.

8. The method of claim 2, wherein said undesirable gases comprise carbon monoxide, carbon dioxide, nitrogen oxides, sulfur oxides, volatile organic compounds, and semi-volatile organic compounds.

9. The method of claim 1, wherein one or more nose wheels or main wheels of said aircraft are equipped with one or more of said drive means.

10. The method of claim 2, wherein noise pollution from operation of said aircraft engines is substantially eliminated.

11. The method of claim 2, wherein one or more nose wheels or main wheels of each of said plurality of aircraft are equipped with one or more of said drive means.

12. A method comprising improving overall exterior and interior air quality within and around airport ground facilities, further comprising equipping substantially all of the aircraft landing on, taxiing on, and taking off from airport ground surfaces with onboard non-engine drive means controllable to maneuver the aircraft independently during ground operations without the use of aircraft main engines or external tow vehicles and minimizing levels of undesirable aircraft engine emission components available to enter exterior or interior air circulation within and around airport ground facilities during airport ground operations.

13. The method of claim 12, wherein said undesirable aircraft engine emission components comprise carbon monoxide, carbon dioxide, nitrogen oxides, sulfur oxides, volatile organic compounds, and semi-volatile organic compounds.

14. The method of claim 13, wherein one or more nose landing gear wheels or main landing gear wheels of substantially all of the aircraft at said airport are equipped with non-engine drive means, and said non-engine drive means are controlled to maneuver said aircraft during ground operations so that said undesirable engine emissions produced by said aircraft when said aircraft is in an airport ramp area are substantially eliminated.

15. The method of claim 12, wherein said airport ground facilities where undesirable aircraft emission components are minimized comprise airport terminal buildings, hangars, maintenance facilities, FAA facilities, parking facilities, control towers, office buildings, and hotels within and near boundaries of an airport.

16. The method of claim 14, wherein said undesirable aircraft engine emission components available to enter interior air circulation in an airport terminal building are minimized.
